(19) United States
(12) Patent Application Publication
(10) Pub. No.: US 2002/0171213 A1
(43) Pub. Date: Nov. 21, 2002

(54) Safety suitcase

(76) Inventor: Yong-Hun Kim, Seoul (KR)

Correspondence Address: Porter, Wright, Morris & Arthur LLP, ATTN: Intellectual Property Department, 28th Floor`, 41 South High Street, Columbus, OH, 43215-6194, US

(21) Appl. No.: 10/142,254

(22) Filed: May 9, 2002

(30) Foreign Application Priority Data
May 17, 2001 (KR) 2001-0014505

(51) Int. Cl. B62B 1/10

(52) U.S. Cl. 280/47.26

(57) ABSTRACT

A safety suitcase according to the present invention enables people who are walking on the streets, riding bicycles or motor cycles, or driving cars to easily notice a cart-carrying pedestrian in a congested place such as terminals, airports or streets crowded with people by the brilliant light emitted from wheels of the cart, and comprises a cart which includes a base for stacking a bag, stays uprightly standing on the base, luminous wheels mounted on both sides of the stays, and a suitcase to be stacked on the base and having bands attached to the back surface thereof to be fitted to the stays, wherein each of the wheels includes a transparent tire, a starting magnet fixed to a wheel shaft, a coil box mounted in the tire to rotate integrally with the tire and incorporating coils having positive and negative terminals, and light emitting diodes which blink when the positive and negative terminals of the coil rotates around the starting magnet in association with the rotation of the tire. A user may carry the cart loaded with the suitcase on his bag like a backpack by shouldering suspenders attached to the suitcase.

### BACKGROUND OF THE INVENTION

1. Field of the Invention

The present invention relates to a safety suitcase which prevents safety accidents that may happen to a pedestrian carrying a cart-type suitcase full of clothing and personal belongings, by alarming drivers of bicycles, motorcycles or automobiles so that they can easily distinguish the pedestrian from others in a congested area such as terminals, airports, or streets by brilliant light emitted from wheels of the safety bag.

2. Description of the Related Art

Frequently, a person carrying a suitcase for travel full of clothing and personal belongings walks in congested areas crowded with other walkers, bicycles, motorcycles and automobiles and crosses intersections.

More specifically, when a pedestrian carries a cart loaded with the suitcase in the nighttime, the person is seldom noticed by drivers and the possibility of safety accidents increases. Therefore, the pedestrian has to pay more attention to the street or road in order to keep his safety and prevent car accidents, especially when crossing the intersections or walking while carrying the cart.

In order to keep the safety of the pedestrian who carries the suitcase in the cart in the night time, it has been suggested that bright colored frames having an excellent light reflexibility such as aluminium be used on the cart or paints in bright colors be painted on the frame.

However, such measures are not sufficient to protect pedestrians from the safety accidents, particularly in the nighttime, and thus new devices, which can keep cart-carrying pedestrians safe, have been demanded.

There have been many kinds of suitcases including wheels. However, wheels may promote the convenient movement of the suitcases, but they do not make the suitcases distinguishable in a dark place such as a basement or in the nighttime.

It is convenient to use an aluminium cart, but it has a limit in that it cannot easily be noticed in the dark place or in the nighttime. Further, it is not possible to carry the aluminum cart on the user's back. That is, the personal cart as described above may transport hand-carrying loads or slightly heavy loads but it is not possible to carry the personal cart on the user's back.

Therefore, the conventional personal cart is useless when passing uneven bumpy roads, stairs or slopes.

### SUMMARY OF THE INVENTION

The present invention is directed to a safety suitcase that substantially obviates one or more of the problems caused by limitations and disadvantages of the prior art.

An object of the present invention is to provide a safety suitcase which enables pedestrians or people riding bicycles or motor cycles or driving cars to easily notice a cart-carrying pedestrian in congested places such as terminals, airports or streets crowded with people by the brilliant light emitted from wheels of a cart, thereby preventing safety accidents and protecting cart-carrying pedestrians from safety accidents.

To achieve these and other advantages and in accordance with the purpose of the present invention, as embodied and broadly described, a safety suitcase of the present invention comprises a cart, and the cart includes a base for stacking a hand-carrying load, stays uprightly standing on the base, luminous wheels mounted on both sides of the stays, and a bag to be stacked on the base and having bands attached to the back surface thereof to be fitted to the stays, wherein each of the wheels includes a transparent tire, a starting magnet fixed to a wheel shaft, a coil box mounted in the tire to rotate integrally with the tire and incorporating coils having positive and negative terminals, and light emitting diodes which blink when the positive and negative terminals of the coil rotate around the starting magnet in association with the rotation of the tire.

Therefore, as a pedestrian pulls the cart after the suitcase is loaded, the light emitting diodes mounted in the coil boxes of the wheels emit brilliant light, so that people can easily notice the pedestrian even in congested and crowded place, thereby increasing the safety of the pedestrian in the crowded place.

Further, if the pedestrian carries the suitcase loaded in the cart on his back, he can easily transport his luggage regardless of the conditions of street such as stairs or slopes.

### BRIEF DESCRIPTION OF THE DRAWINGS

The accompanying drawings, which are included to provide a further understanding of the invention and are incorporated in and constitute a part of this specification, illustrate an embodiment of the invention and together with the description serve to explain the principles of the invention.

In the drawings:

FIG. 1 is a perspective view showing a cart according to the present invention;

FIG. 2 is a disassembled view of a luminous wheel excluding a tire;

FIG. 3 is a side elevational view of the luminous wheel;

FIG. 4 is a cross-sectional view of the luminous wheel partially taken along line I-I of FIG. 3;

FIG. 5 is a side elevational view of a safety suitcase; 20 FIG. 6 is a side elevational view of the safety suitcase, which is partially cut;

FIG. 7 is an illustrative view showing the safety suitcase put on shoulders of a pedestrian; and

FIG. 8 is a side view of the safety suitcase when it is dragged.

### DETAILED DESCRIPTION OF THE PREFERRED EMBODIMENTS

Reference will now be made in detail to a preferred embodiment of the present invention.

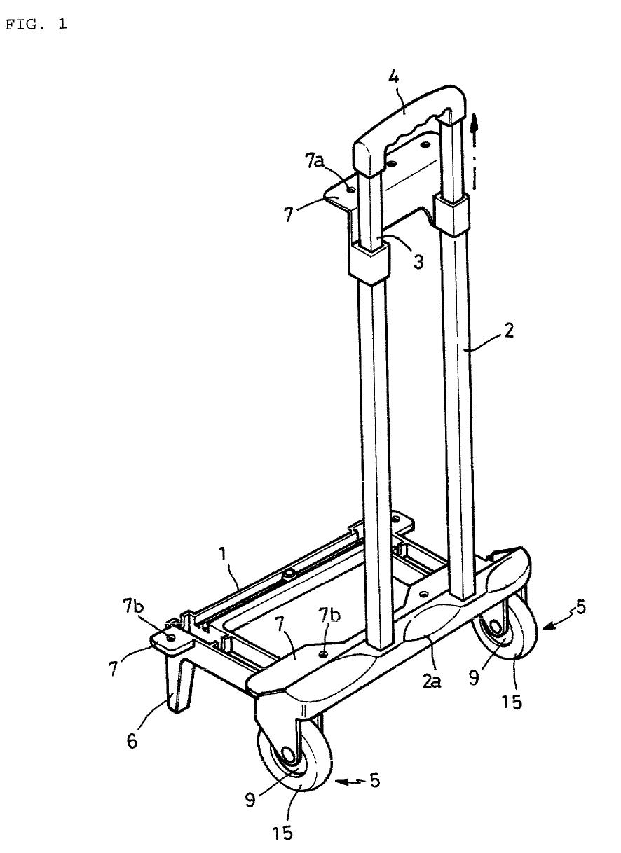

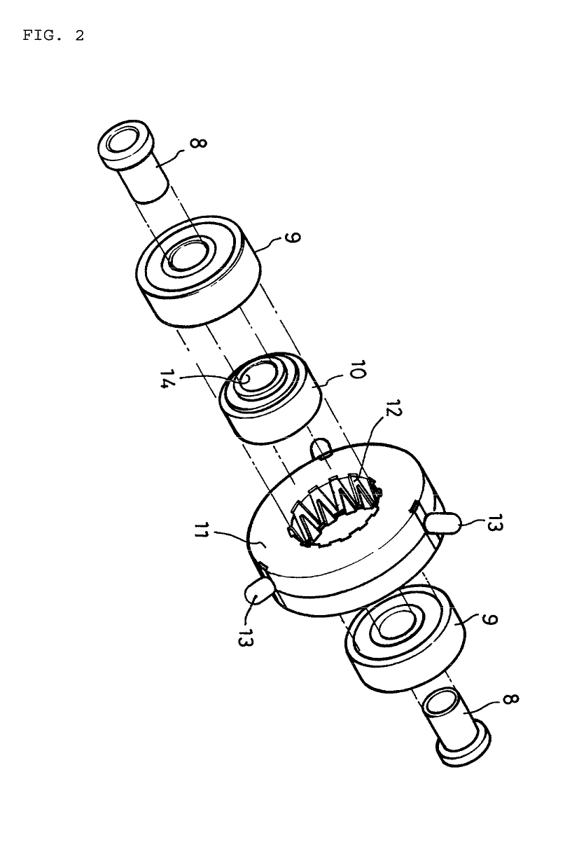

FIG. 1 is a perspective view showing a safety suitcase according to the present invention. In FIG. 1, a cart A of the present invention comprises a base 1, stays 2, a central frame 2a, a pulling element 3 having a handle part 4, legs 6 mounted under the rear part of the base 1 to support the rear part of the base, a fixing plate 7, and fixing holes 7a and 7b, wherein luminous wheels 5, each of which is composed of a starting magnet, a coil box, coils and light emitting diodes, are axially mounted on both end sides of the central frame of the cart A.

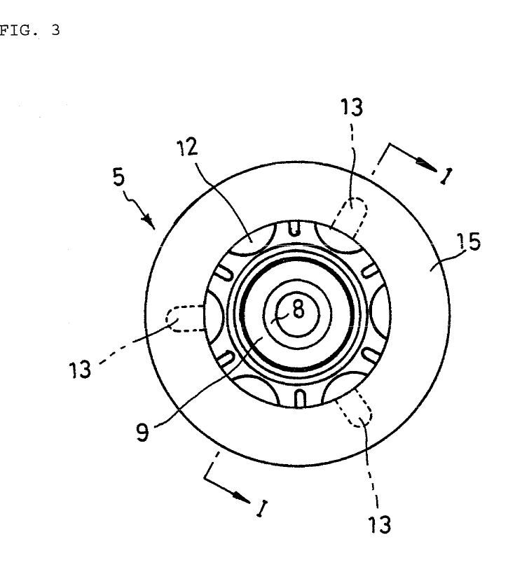

Referring to FIG. 2, the luminous wheels 5 emit light from the inside when rolling. Specifically, each of the luminous wheels comprises bushings 8 to be fitted on a shaft of the wheel (not shown), bearings 9 to be coupled with the respective bushings, a starting magnet 10 closely fitted on front ends of the bushings and maintained fixed thereto, a coil box 11 having a power generating coil 12 mounted on an inner periphery and a plurality of light emitting diodes 13 on outer periphery, and a tire surrounding the coil box 11 and made of strong and transparent resin.

The starting magnet 10 is formed in the shape of a donut, and includes a tube type sleeve 14 in the center and a magnet attached to the sleeve. The sleeve 14 is axially fitted on the bushing 8 to be closely fixed in the wheel 5 and functions to connect or disconnect positive and negative terminals of the coil box 11, which rotates in association with the tire, thereby blinking the light emitting diodes 13.

The coil 12 is in a core formed zigzag on an inner peripheral surface of the coil box 11 and allows the light emitting diodes 13 to blink with micro current generated according to the self-generating theory when the coil rotates around the starting magnet 10.

The light emitting diodes 13 have different colors as desired to attract eyes of drivers and walkers at a glance in the nighttime.

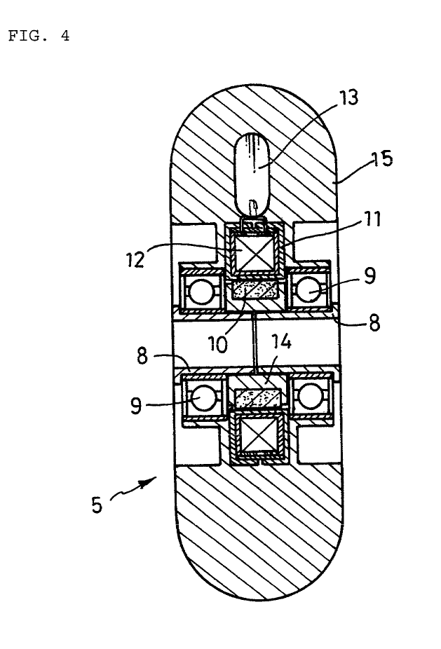

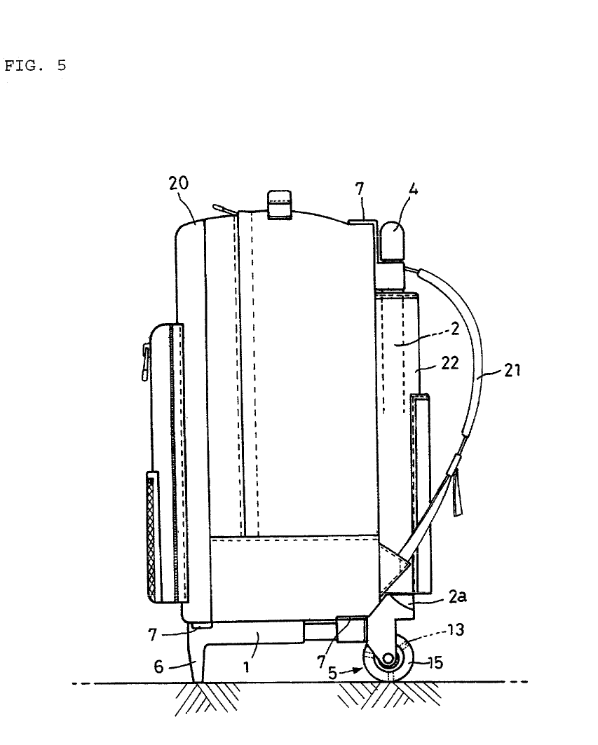

As shown in FIG. 3 and FIG. 4, in the luminous wheel 5, both bushings 8 are fitted with the bearings 9 first, and after the starting magnet 10 is loosely fitted to the center of the coil box 11 combining the coil 12 and the light emitting diodes 13, one of the bushing 9 coupled with one of the bearings 9 is fitted with the starting magnet 10.

Then, the other bushing 8 coupled with the other bearing 9 is fitted with the other side of the starting magnet 10 and the starting magnet 10 is fixed tight on the bushings 9 by applying pressure in an axial direction. The starting magnet 10 fixed tight is secured in a wheel mold, and the transparent resin is injection molded to be formed into the tire 15. When the tire is molded, the finished tire is removed from the mold.

By molding the tire 15 in such a manner, the outer periphery of the bearings 9 and the coil box 11 including the light emitting diodes 13 are buried in the tire 15 integrally, while the inner periphery of the bearings 9 and the bushings 8 are separated from the tire 15 to move separately.

When a pedestrian pulls the cart A mounted with such luminous wheels 5, the tires 15, the coil boxes 11 and the light emitting diodes 13 rotate in association with the pulling of the cart. At this moment, the coil 12 rotates around the starting magnet 10 for the self-generation of electricity of the positive and negative terminals of the coil box 11, resulting in the blinking of the light emitting diodes 13, thereby transmitting the blinking light outside the transparent tire.

Therefore, the safety suitcase including the luminous wheels enables people, who are walking on the streets, riding bicycles or motor cycles, or driving cars, to easily notice a pedestrian carrying a cart-type suitcase in congested areas such as terminals, airports, market places or other streets crowded with people where more careful attention should be paid, particularly at night, thereby preventing the safety accidents possibly caused to the cart-carrying pedestrian. The pedestrian may pull the cart A loaded with the suitcase safely in the nighttime and in the dark places.

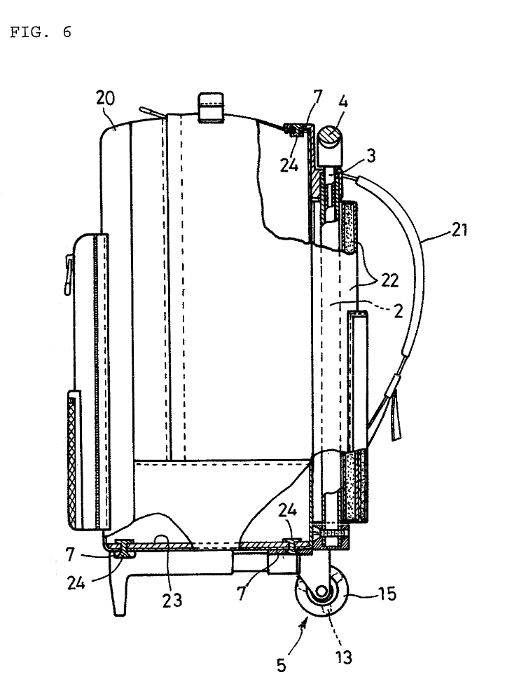

In FIG. 5, the cart A is loaded with a suitcase 20 to which suspenders 21 are attached. The suitcase 20 includes a band 22 on a back surface and the band 22 is opened at upper and lower end parts to cover the stays 2 of the cart A.

Upper and lower ends of the suspenders 21 are fixed to upper and lower ends of the back surface of the suitcase 20 on both sides of a pad sheet 22, which protects the back of a user when the user carries the cart on his back.

Referring to FIG. 6, the bottom part of the suitcase 20 is formed in a corrugated cardboard type 23 made of rigid synthetic resin, and the corrugated bottom part 23 includes attachment holes on its surface to be fixed to the base 1 of the cart A by inserting rivets 24 through the fixing holes 7a and 7b of the cart A. Then, the suitcase 20 is integrated with the cart A.

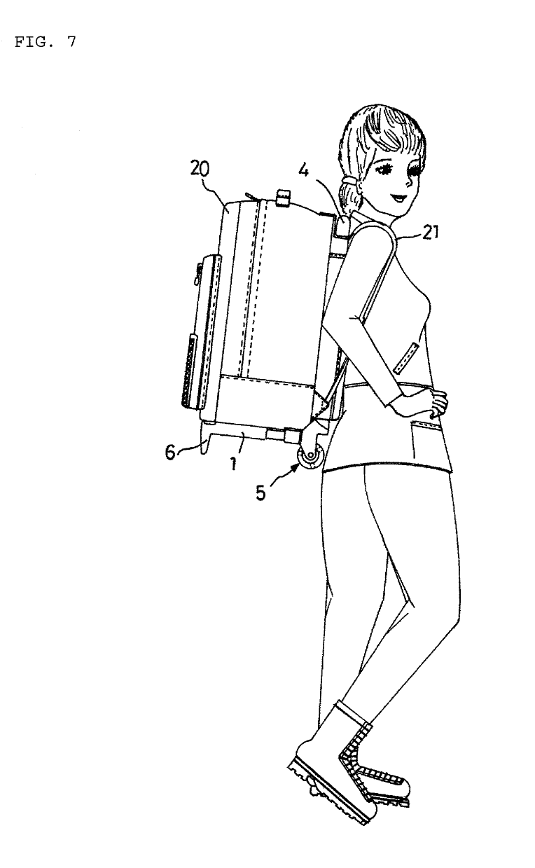

Referring to FIG. 7, if the user carries the cart A loaded with the suitcase 20 on his back by the suspenders 21, he may conveniently pass along slopes and stairs, climb mountains, get on or off buses, subway trains and railroad trains, or air planes.

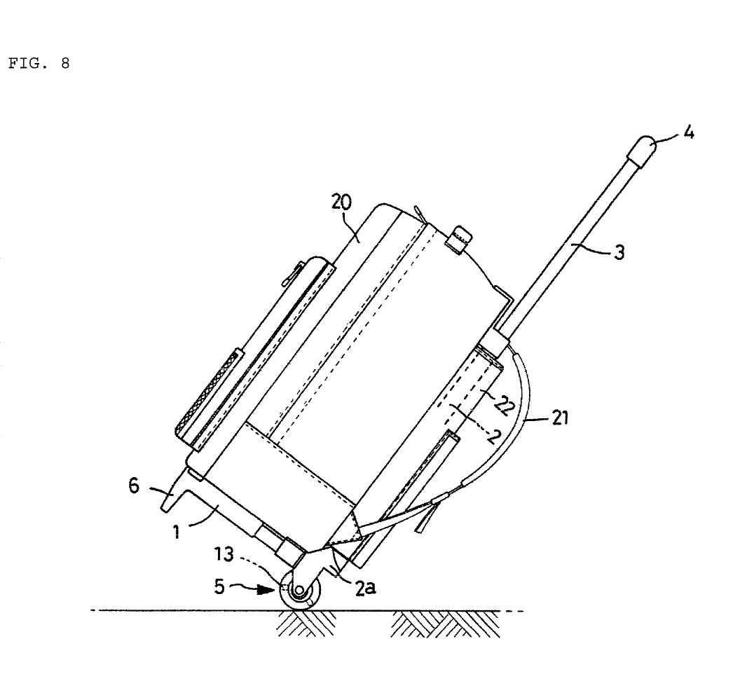

As shown in FIG. 8, the user may conveniently carry the cart A by pulling the handle part after withdrawing the pulling element 3 from the stays 2 appropriately according to his height.

As described herein above, according to the present invention, the cart-type suitcase is easily noticeable by the brilliant blinking light emitted from the luminous wheels when a pedestrian is pulling the cart loaded with the suitcase, particularly in the night time and in the dark places, and thus it contributes to the safe walking of the cart-carrying pedestrian and other pedestrians and safe driving of vehicle drivers.

Further, the user may carry the cart loaded with the suitcase on his bag when passing along uneven roads, slopes, mountain roads, or using trains or airplanes.

It will be apparent to those skilled in the art that various modifications and variations can be made to the device of the present invention without departing from the spirit and scope of the invention. The present invention covers the modifications and variations of this invention provided they come within the scope of the appended claims and their equivalents.

What is claimed is:

1. A safety suitcase, comprising a cart which includes a base for stacking a bag, stays uprightly standing on the base, luminous wheels mounted on both sides of the stays, and a suitcase to be stacked on the base and having bands attached to the back surface thereof to be fitted to the stays, wherein each of the wheels includes a transparent tire, a starting magnet fixed to a wheel shaft, a coil box mounted in the tire to rotate integrally with the tire and incorporating coils having positive and negative terminals, and light emitting diodes which blink when the positive and negative terminals of the coil rotate around the starting magnet in association with the rotation of the tire.

2. A safety suitcase as claimed in claim 1, wherein each of the luminous wheels comprises a transparent tire integrally mounted outside the coil box to transmit the light from the light emitting diodes to the outside.

3. A safety suitcase as claimed in claim 1, wherein the light emitting diodes are attached along the periphery of the coil box at a uniform interval and have different colors.
